(19) United States
(12) Patent Application Publication
(10) Pub. No.: US 2009/0109832 A1
(43) Pub. Date: Apr. 30, 2009

(54) Recording Disc

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 11/989,196

(22) PCT Filed: Jul. 20, 2006
(86) PCT No.: PCT/JP2006/314395

§ 371 Date: Jan. 22, 2008

(30) Foreign Application Priority Data
Jul. 20, 2005 (JP) 2005-210384

(51) Int. Cl. G11B 7/24

(52) U.S. Cl. 369/275.4; G9B/7.139

(57) ABSTRACT

A second layer is a recording-enabled layer (15) where content data can be additionally written or rewritten and a first layer is reproduction-dedicated layer (14) where no wobble is formed. Furthermore, the reproduction-dedicated layer (14) contains CSS encryption data (17) and an identifier (19) indicating that it is dedicated for reproduction

### TECHNICAL FIELD

The present invention relates to a recording disk which is suited to record content data, such as video images and music.

### BACKGROUND ART

Recently, DVDs have been widely distributed as media for recording content data, such as video images and music. Lately, there have been distributed not only read-only DVDs but also recordable DVDs which can write-once or rewrite the content data.

In the read-only DVD, in order to record the content data onto the DVD, the recording surface of the DVD is embossed by using a stampa. Thus, it is expensive to make the DVD on which the content data is recorded. Thus, the read-only DVD is suited to mass-produce the DVDs on which a movie work is recorded and to widely sell them in the nationwide market. In contrast, the read-only DVD is not suited to produce the DVDs on which video images for PR activities of local governments or companies are recorded in small quantities and to provide them to a particular area or particular client or the like. That is, it is too expensive to make a stampa only for the small-quantity production.

On the other hand, in the case of the recordable DVD, the content data can be easily recorded onto the DVD by using a DVD recorder. That is, if the content data whose recording is desired is given to the DVD recorder and a recording start button of the DVD recorder is pressed, the DVD recorder irradiates the recording surface of the recordable DVD with a light beam modulated on the basis of the content data, to thereby record the content data. Thus, it is not so expensive to make the DVD on which the content data is recorded. Thus, the recordable DVD is suited to produce the DVDs on which video images for PR activities of local governments or companies are recorded, in small quantities.

### DISCLOSURE OF INVENTION

### Subject to be Solved by the Invention

By the way, an encryption method for copyright protection about video recording on the DVD includes CSS (Content Scramble System) and CPRM (Content Protection for Recordable Media). The CSS is employed in the read-only DVD. The CPRM is employed in the recordable DVD.

Almost all the DVD players (reproducing apparatuses) which are currently popular support the CSS, and they can decode and reproduce the content data encoded by the CSS and recorded on the DVD. However, some of the currently popular DVD players do not support the CPRM and cannot reproduce the content data encoded by the CPRM and recorded on the DVD.

Here, let us look back at how the DVD has become popular like what it is today. Currently, not only the read-only DVD but also the recordable DVD is also widely distributed. However, at the initial stage when the DVD appeared in the market, there was only the read-only DVD in the market. The recordable DVD appeared in the market after the read-only DVD was widely distributed.

Thus, at the initial stage when the DVD appeared in the market, the DVD player that employed the CSS, which is the encryption method of the read-only DVD, was popular in the market. The DVD player that employed the CPRM, which is the encryption method of the recordable DVD, was marketed after the DVD player that employed the CSS.

As a result, currently, at home and at offices, there are many so-called old type DVD players that employ the CSS but not the CPRM. This old type of DVD player cannot reproduce the content data encrypted by the CPRM.

This may cause the following problem. That is, if local governments or companies use the DVD recorder to record the content data about PR activity video images or the like onto the recordable DVD, the content data is encrypted by the CPRM. Therefore, even if the local governments or companies produce the recordable DVDs on which the content data about PR activity video images or the like is recorded in small quantities, the old type of DVD player cannot reproduce the content data as long as the content data is encrypted by the CPRM. This may limit the viewers of contents, and there is the possibility that the contents cannot be widely distributed nor sold.

In view of the above-exemplified problem, it is therefore a first object of the present invention to provide a recording disk on which the content data can be written once or rewritten and which can broaden the model or type of a reproducing apparatus that can decode and reproduce the encrypted and recorded content data.

It is a second object of the present invention to provide a recording disk on which the content data can be written once or rewritten and on which the encrypted and recorded content data can be reproduced even by a reproducing apparatus that employs the CSS but not the CPRM.

### Means for Solving the Subject

The above object of the present invention can be achieved by a first recording disk provided with: a substrate; and two or more recording layers which are all laminated on one surface of the substrate or which are separately formed on both surfaces, the recording layer including: a read-only layer having an area which has a physical structure different from that of a recordable area in which content data can be recorded later, which is read-only, and which is irradiated with a light beam by a reproducing apparatus to judge a type of the disk; and a recordable layer in which wobble is formed and which has the recordable area, encrypted data by a CSS (Content Scramble System) encryption method being recorded in advance as embossed pits in the read-only layer.

The above object of the present invention can be achieved by a second recording disk provided with: a substrate; and a recording layer formed on the substrate, in the recording layer there are formed: a read-only area which has a physical structure different from that of a recordable area in which content data can be recorded later; and the recordable layer in which the content data can be recorded later, encrypted data by a CSS (Content Scramble System) encryption method and one portion or all of a file system being recorded in advance in the read-only area.

The above object of the present invention can be achieved by a third recording disk provided with: a substrate; and a recording layer formed on the substrate, in the recording layer there are formed: a read-only area in which wobble is formed; and the recordable layer in which the wobble is formed and in which content data can be recorded later, encrypted data by a CSS (Content Scramble System) encryption method and data including one portion or all of a file system being recorded in advance in the read-only area, the data recorded in the read-only area being arranged undulantly having a phase 180 degrees different from that of the wobble formed in the read-only area.

These effects and other advantages of the present invention will become more apparent from the embodiments and examples explained below.

### BRIEF DESCRIPTION OF DRAWINGS

FIG. 1 is a cross sectional view showing an embodiment of the recording disk of the present invention.

FIG. 2 is a cross sectional view showing another embodiment of the recording disk of the present invention.

FIG. 3 is an explanatory view showing a dual-layer hybrid DVD, which is an example of the recording disk of the present invention.

FIG. 4 is an explanatory view showing a dual-layer hybrid DVD, which is another example of the recording disk of the present invention.

FIG. 5 is an explanatory view showing a single-layer hybrid DVD, which is an example of the recording disk of the present invention.

FIG. 6 is an explanatory view showing a groove on the single-layer hybrid DVD in FIG. 5.

FIG. 7 is an explanatory view showing a single-layer hybrid DVD, which is another example of the recording disk of the present invention.

FIG. 8 is an explanatory view showing a groove on a single-layer hybrid DVD, which is another example of the recording disk of the present invention.

FIG. 9 is an explanatory view showing a groove on a single-layer hybrid DVD, which is another example of the recording disk of the present invention.

### DESCRIPTION OF REFERENCE CODES

10, 20 recording disk
11, 13, 21, 23, 41, 43, 71, 73 substrate
12, 22, 42, 72 recording layer
14, 44 read-only layer
15, 45 recordable layer
17, 27, 53, 85 encrypted data
18, 28, 54, 61A, 62B, 86 file system
19, 29, 52, 84 identification information
13, 75 read-only area
25, 74, 76 recordable area
40, 60 dual-layer hybrid DVD
70 single-layer hybrid DVD
46, 81 lead-in area
47, 82 user data area
87 dummy data

### BEST MODE FOR CARRYING OUT THE INVENTION

Hereinafter, the best mode for carrying out the invention will be explained in each embodiment in order, with reference to the drawings.

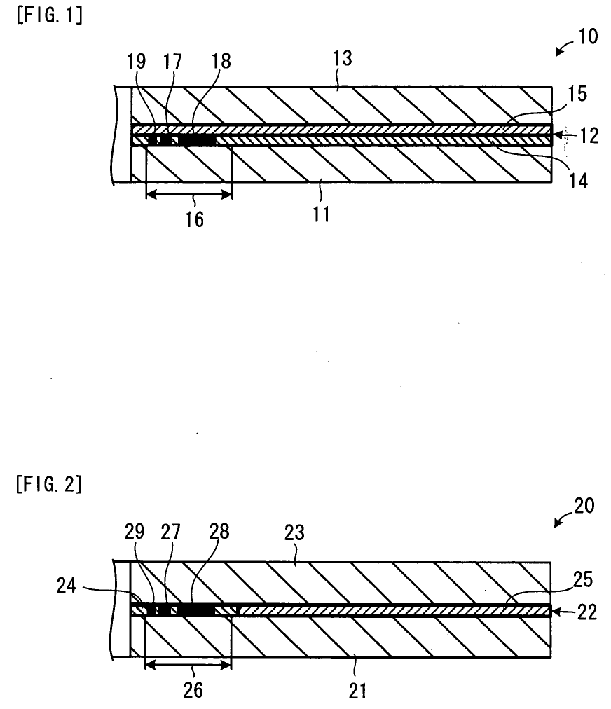

FIG. 1 shows an embodiment of the recording disk of the present invention. A recording disk 10 in FIG. 1 is suited to be used as a recording medium on which content data, such as video images and music, is recorded. The recording disk 10 is, for example, a DVD. Incidentally, the recording disk of the present invention is not limited to the DVD but is also applied to other recording disks, such as a Blu-ray Disc and a HD-DVD.

As shown in FIG. 1, the recording disk 10 is provided with: a substrate 11; a recording layer 12 formed on the substrate 11; and a substrate 13 disposed on the recording layer 12. The recording disk 10 is a dual-layer recording disk. The recording layer 12 is formed by overlapping a first layer and a second layer. Incidentally, the shape and the thickness or the like of the substrates 11 and 13 and the recording layer 12 can be set the same as in the normal DVD.

The recording disk 10 is a hybrid disk having properties of both a read-only disk and a recordable disk. That is, the first layer is a read-only layer 14. The read-only layer 14 does not have wobble formed, and it is read-only, i.e. not additionally recordable and non-rewritable. On the other hand, the second layer is a recordable layer 15. The recordable layer 15 has the wobble formed, and the content data can be written once or rewritten thereon.

The read-only layer 14 has an area 16 which is irradiated with a light beam by a reproducing apparatus in order to judge the disc type. Hereinafter, the area irradiated with the light beam by the reproducing apparatus in order to judge the disc type is referred to as a “disk type judgment area”.

Moreover, in the read-only layer 14, encrypted data 17 in a CSS encryption method and a file system 18 are recorded in advance as embossed pits. Moreover, in the read-only layer 14, identification information 19 which indicates being read-only is recorded in advance as the embossed pits.

The recording of the content data onto the recording disk 10 is performed, for example, as follows. When the production of the recording disk 10 is completed and the recording disk 10 is shipped, the encrypted data 17, the file system 18, and the identification information 19 are recorded in advance as the embossed pits in the read-only layer 14 of the recording disk 10.

For example, a content producer who has purchased the recording disk 10 records the content data (e.g. video data in which PR activities of local governments and companies are recorded, or the like) into the recordable layer 15 of the recording disk 10. When the content data is recorded into the recordable layer 15, the content data is encrypted by the CSS if needed. When the content data is encrypted by the CSS, the encrypted data 17 is used which is recorded in advance in the read-only layer 14 of the recording disk 10 on which the content data is about to be recorded. Incidentally, when the content data is encrypted by the CSS and is recorded into the recordable layer 15, a recording apparatus is used which has a function of encrypting the content data by the CSS and recording it.

Moreover, the file system 18 includes management data which indicates the recording position of the file of the content data recorded in the recordable layer 15. The file system 18 is recorded in the read-only layer 14 in advance as the embossed pits, and it cannot be rewritten later. Thus, the management data in the file system 18 cannot be rewritten later. Thus, the recording position of the file of the content data recorded in the recordable layer 15 is fixed in advance. Thus, when the content data is recorded into the recordable layer 15, the content data is authored such that the recording position of the file of the content data matches the recording position indicated by the management data in the file system 18. For example, in the authoring, the recording bit rate of the content data is adjusted, or dummy data is inserted into the content data, so that the size of the file of the content data is adjusted such that the recording position of the file of the content data matches the recording position indicated by the management data.

The reproduction of the content data encoded by the CSS and recorded in the recordable layer 15 is performed, for example, as follows. A consumer who has obtained the recording disk 10 on which the content data encrypted by the CSS is recorded in the recordable layer 15 reproduces the content data recorded on the recording disk 10 by using a reproducing apparatus (e.g. DVD player) owned by the consumer.

Firstly, if the consumer inserts the recording disk 10 into the reproducing apparatus, the reproducing apparatus performs an operation of judging the type of the recording disk 10. For example, most of the distributed DVD players refer to the identification information recorded on the DVD and detect the presence or absence of the wobble on the DVD, to thereby judge the type of the DVD, such as a read-only DVD (e.g. DVD-ROM) and a recordable DVD (e.g. DVD-R, DVD-RW).

According to the DVD standard, the recording position of the identification information is in a lead-in area of the first layer. If the recording disk 10 is a DVD, in accordance with this standard, the identification information 19 on the recording disk 10 is recorded in advance in the lead-in area of the first layer, i.e. the read-only layer 14. Then, the identification information 19 indicates being read-only. Therefore, the DVD player reads the identification information 19 from the recording disk 10 and refers to it, to thereby recognize that the recording disk 10 is the read-only DVD.

Moreover, when judging the type of the DVD, the distributed DVD players of various models or types irradiate a light beam from a surrounding position where the identification information is recorded in the lead-in area of the first layer of the DVD to an inner circumferential portion in a user data area following the lead-in area, to thereby detect whether or not there is the wobble in the recording layer of the DVD. That is, the disk type judgment area of the DVD is from the surrounding position where the identification information is recorded in the lead-in area of the first layer to the inner circumferential portion in the user data area following the lead-in area. If the wobble is not detected after the DVD player irradiates the light beam to scan the disk type judgment area, the DVD player recognizes that the DVD is the read-only DVD.

On the recording disk 10, the area from the surrounding position where the identification information 19 is recorded in the lead-in area of the first layer to the inner circumferential portion in the user data area following the lead-in area, i.e. the disk type judgment area 16, exists in the read-only layer 14. Then, there is no wobble formed in the read-only layer 14. As a result, if the recording disk 10 is a DVD, the DVD player recognizes that the recording disk 10 is the read-only DVD.

As described above, the reproducing apparatus judges that the recording disk 10 is the read-only disk, by the double checking which is referring to the identification information 19 and detecting the presence or absence of the wobble.

Then, the reproducing apparatus reads the encrypted data 17 by the CSS recorded in the read-only layer 14 of the recording disk 10, and decodes the content data recorded in the recordable layer 15. Then, the reproducing apparatus reproduces the decoded content data.

The distributed DVD players include a model which supports only the CSS encryption method and a model which supports not only the CSS encryption method but also the CRPM encryption method. Any model allows the decoding and reproduction of the content data when the type of the DVD is judged to be the read-only type and when the content data recorded on the DVD is encrypted by the CSS. Therefore, even if the recording disk 10 has the recordable layer 14 and the content data can be written once or rewritten into the recordable layer 15, the DVD player allows the decoding and reproduction of the content data when the type of the recording disk 10 is judged to be the read-only type and when the content data recorded in the recordable layer 15 of the recording disk 10 is encrypted by the CSS.

As explained above, the recording disk 10 has: the recordable layer 15 in which the content data can be written once or rewritten, as the second layer; and the read-only layer 14 in which the wobble is not formed, as the first layer. Moreover, the encrypted data 17 by the CSS and the identification information 19 which indicates being read-only are recorded in advance in the read-only layer 14. By this, it is possible to realize the additional recording or rewriting of the content data, and it is possible to judge the type of the recording disk 10 to be the read-only type on the reproducing apparatus. By this, it is possible to decode and reproduce the content data encrypted by the CSS and recorded on the recording disk 10, on the reproducing apparatus.

Therefore, according to the recording disk 10, the encrypted content data can be easily recorded onto the recording disk 10 without using a stampa, and at the same time, it is possible to broaden the model or type of the reproducing apparatus that can decode and reproduce the content data encrypted and recorded on the recording disk 10. Thus, for example, local governments or companies can inexpensively produce the recording disks on which the content data, such as PR activity video images, even in small quantities, and the PR activity video images or the like recorded on the recording disks can be watched by more people. That is, according to the recording disk 10, it is possible to reduce the cost of the small-quantity production of the contents, and it is possible to increase the number of viewers of the produced contents.

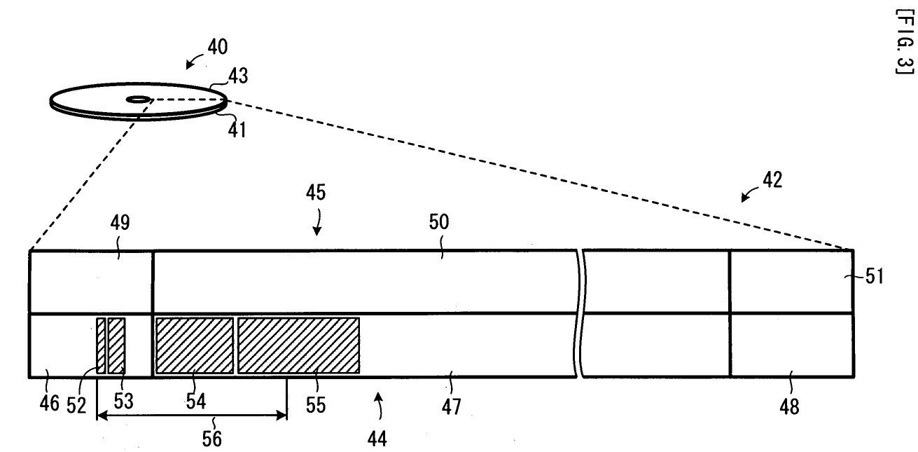

Incidentally, the recording disk of the present invention is not limited to the dual-layer recording disk. For example, the recording disk of the present invention may be a single-layer recording disk 20 as shown in FIG. 2. That is, a recording layer 22 is formed on a substrate 21, and a substrate 23 is formed on the recording layer 22. Then, in the recording layer 22, there are formed: a read-only area 24 in which the wobble is not formed; and a recordable area 25 in which the wobble is formed. The position and range of the read-only area 24 are set to include a disk type judgment area 26 in the read-only area 24. Moreover, in the read-only area 24, encrypted data 27 by the CSS and a file system 28 are recorded in advance. Moreover, in the read-only area 24, identification information 29 which indicates being read-only is recorded in advance.

### EXAMPLE 1

Hereinafter, a first example of the present invention will be explained with reference to the drawings. In the following example, the recording disk of the present invention is applied to a dual-layer hybrid DVD.

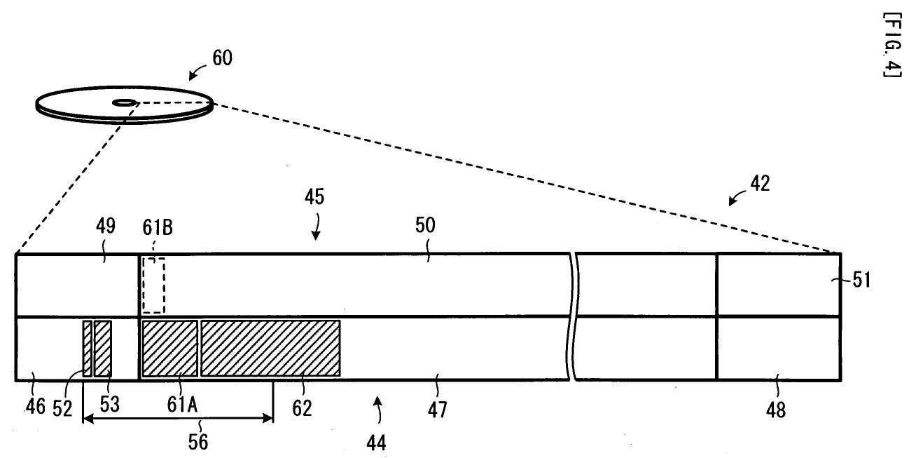

FIG. 3 shows a dual-layer hybrid DVD, which is the example of the recording disk of the present invention. As shown in FIG. 3, in a dual-layer hybrid DVD 40, a recording layer 42 is formed on a substrate 41, and a substrate 43 is formed on the recording layer 42. The recording layer 42 is provided with a first layer (layer 0) and a second layer (layer 1). The first layer is located closer to the substrate on the irradiation side of a light beam than the second layer, in the dual-layer hybrid DVD 40. The dual-layer hybrid DVD 40 employs a method in which recording and reading are performed from the inner circumferential side to the outer circumferential side of the substrate 41, in both the first layer and the second layer; namely, a parallel track path method.

The first layer of the dual-layer hybrid DVD 40 does not have the wobble formed, and it is a read-only layer 44. The read-only layer 44 has the same structure as that of the recording layer of a DVD-ROM, for example. The second layer has the wobble formed, and it is a recordable layer 45 in which the content data can be written once. The recordable layer 45 has the same structure as that of the recording layer of a general DVD-R, for example, and it is formed of an organic dye material. Incidentally, the recordable layer 45 may be formed of a phase change material as in the recording layer of a general DVD-RW so as to be an area in which the content data can be rewritten.

In the read-only layer 44, a lead-in area 46 is formed on the inner circumferential side, a user data area 47 is formed on the outer circumferential side of the lead-in area 46, and a lead-out area 48 is formed on the outer circumferential side of the user data area 47. In the recordable layer 45, a lead-in area 49 is formed on the inner circumferential side, a user data area 50 is formed on the outer circumferential side of the lead-in area 49, and a lead-out area 51 is formed on the outer circumferential side of the user data area 50.

In the lead-in area 46 of the read-only layer 44, identification information 52 which indicates being read-only is recorded in advance as the embossed pits. Moreover, in the lead-in area 46 of the read-only layer 44, encrypted data 53 by the CSS encryption method is recorded in advance as the embossed pits.

Moreover, in the read-only layer 44, an entire file system 54 is recorded in advance as the embossed pits in an inner circumferential portion of the user data area 47 following the lead-in area 46. Moreover, in the user data area 47 of the read-only layer 44, content data 55 is recorded in advance as the embossed pits, if needed, in a portion following the file system 54.

Moreover, the read-only layer 44 has an area which is irradiated with a light beam by a DVD player in order to judge the disc type; namely, a disk type judgment area 56. The disk type judgment area 56 is located from a surrounding position where the identification information 52 is recorded in the lead-in area 46 of the read-only layer 44 (e.g. from immediately before the head position of the identification information 52) to an inner circumferential portion of the user data area 47 following the lead-in area 46.

On the other hand, the user data area 50 of the recordable layer 45 is unrecorded when the production of the dual-layer hybrid DVD 40 is completed and the dual-layer hybrid DVD 40 is shipped. Of course, the file system 54 is recorded in advance in the read-only layer 44, and the file system includes in advance management data which indicates the recording position of the file of the content data recorded in the recordable layer 45. Thus, the recording position of the file of the content data recorded in the recordable layer 45 is fixed in advance.

The recording of the content data onto the dual-layer hybrid DVD 40 is performed, for example, as follows. A content producer who has purchased the dual-layer hybrid DVD 40 records the content data into the recordable layer 45 of the dual-layer hybrid DVD 40. When the content data is recorded into the recordable layer 45, the content data is encrypted by the CSS if needed. When the content data is encrypted by the CSS, the encrypted data is used which is recorded in advance in the read-only layer 44 of the dual-layer hybrid DVD 40. Incidentally, when the content data is encrypted by the CSS and is recorded into the recordable layer 45, a recording apparatus is used which has a function of encrypting the content data by the CSS and recording it.

Moreover, the recording position of the file of the content data to be recorded into the recordable layer 45 is determined in advance by the management data in the file system 54 recorded in the read-only layer 44. Thus, when the content data is recorded into the recordable layer 45, the content data is authored such that the recording position of the file of the content data matches the recording position indicated by the management data in the file system 54.

The reproduction of the content data encoded by the CSS and recorded in the recordable layer 45 is performed, for example, as follows. A consumer who has obtained the dual-layer hybrid DVD 40 on which the content data encrypted by the CSS is recorded in the recordable layer 45 reproduces the content data recorded on the dual-layer hybrid DVD 40 by using a DVD player owned by the consumer.

Firstly, if the consumer inserts the dual-layer hybrid DVD 40 into the DVD player, the DVD player performs an operation of judging the type of the dual-layer hybrid DVD 40. Specifically, the DVD player refers to the identification information 52 recorded on the dual-layer hybrid DVD 40 and detects the presence or absence of the wobble by irradiating the disk type judgment area 56 in the read-only layer 44 of the dual-layer hybrid DVD 40 with a light beam.

The identification information 52 recorded on the dual-layer hybrid DVD 40 indicates being read-only. Moreover, the wobble is not formed in the read-only layer 44. Therefore, the DVD player recognizes that the dual-layer hybrid DVD 40 is the read-only DVD.

Then, the DVD player reads the encrypted data 53 by the CSS recorded on the dual-layer hybrid DVD 40, and decodes the content data recorded in the recordable layer 45 by using the encrypted data 53. Then, the DVD player reproduces the decoded content data.

As explained above, the dual-layer hybrid DVD 40 has: the recordable layer 45 in which the content data can be written once, as the second layer; and the read-only layer 44 in which the wobble is not formed, as the first layer. Moreover, the identification information 52 which indicates being read-only and the encrypted data 53 by the CSS are recorded in advance in the read-only layer 44. By this, it is possible to realize the additional recording of the content data, and it is possible to judge the type of the dual-layer hybrid DVD 40 to be the read-only DVD on the DVD player. By this, it is possible to decode and reproduce the content data encrypted by the CSS and recorded on the dual-layer hybrid DVD 40, on the DVD player.

Therefore, according to the dual-layer hybrid DVD 40, the encrypted content data can be easily recorded onto the dual-layer hybrid DVD 40 without using a stampa, and at the same time, it is possible to broaden the model or type of the DVD player that can decode and reproduce the content data encrypted and recorded on the dual-layer hybrid DVD 40. Thus, for example, local governments or companies can inexpensively produce the recording disks on which the content data, such as PR activity video images, even in small quantities, and the PR activity video images or the like recorded on the recording disks can be watched by more people. That is, according to the dual-layer hybrid DVD 40, it is possible to reduce the cost of the small-quantity production of the contents, and it is possible to increase the number of viewers of the produced contents.

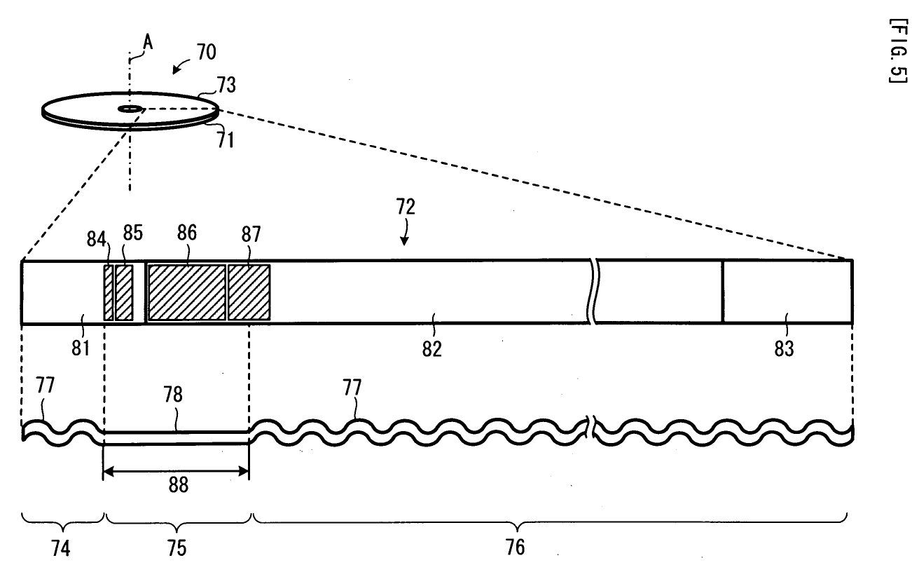

Incidentally, the aforementioned dual-layer hybrid DVD 40 employs such construction that the entire file system 54 is recorded in advance in the user data area 47 of the read-only layer 44. The present invention, however, is not limited to this. That is, as in a dual-layer hybrid DVD 60 shown in FIG. 4, the file system is divided into a first portion 61A and a second portion 61B, and only the first portion 61A is recorded in advance as the embossed pits in the user data area 47 of the read-only layer 44. The first portion 61A of the file system does not include the management data which indicates the recording position of the file of the content data to be recorded into the recordable layer 45. The second portion 61B includes the management data.

The second portion 61B of the file system is recorded by a recording apparatus into an inner circumferential portion of the user data area 50 of the recordable layer 45 after the recording of the content data is ended in the user data area 50 of the recordable layer 45. That is, after the recording of the content data into the user data area 50 is completed and the recording position of the file of the content data is determined, the management data which describes the determined file recording position is generated by the recording apparatus, and the second portion 61B of the file system including the management data is recorded by the recording apparatus into the recordable layer 45. By this, the recording position of the file of the content data to be recorded into the recordable layer 45 can be arbitrarily set in a range of an unrecorded area in the user data area 50 of the recordable layer 45 (except for a reserve area of the second portion 61b of the file system, or the like).

Moreover, in order to reproduce the content data 55 recorded by embosses or the like in advance in the user data area 47, information for reproducing the content data may be written once in the second portion 61B of the file system subsequently recorded. By this, for example, there may be provided a difference in a charge to watch the contents, and the content data 55 is to be reproduced according to the corrected charge.

### EXAMPLE 2

Hereinafter, a second example of the present invention will be explained with reference to the drawings. In the following example, the recording disk of the present invention is applied to a single-layer hybrid DVD.

FIG. 5 shows a single-layer hybrid DVD, which is the example of the recording disk of the present invention. As shown in FIG. 5, in a single-layer hybrid DVD 70, a recording layer 72 is formed on a substrate 71, and a substrate 73 is formed on the recording layer 72. The material of the recording layer 72 is, for example, the same organic dye material as that used for the recording layer of a general DVD-R. Incidentally, the material of the recording layer 72 may be the same phase change material as that used for the recording layer of a general DVD-RW.

A recordable area 74 is formed on the inner circumferential side of the recording layer 72, a read-only area 75 is formed on the outer circumferential side of the recordable layer 74, and a recordable area 76 is formed on the outer circumferential side of the read-only layer 75. The recordable area 74 and the read-only area 75 are continued, and the read-only area 75 and the recordable area 76 are continued. The recordable area 76 spreads to the outer circumferential side of the recording layer 72.

The recordable areas 74 and 76 are areas in which the content data can be written once. Each of the recordable areas 74 and 76 has a wobbled groove 77 in which the wobble is formed. Incidentally, by forming the recording layer 72 of the phase change material, the recordable areas 74 and 76 can be set to areas in which the content data can be rewritten.

The read-only area 75 is a read-only area. The read-only area 75 has a normal groove 78 in which the wobble is not formed.

The recording layer 72 is divided into the recordable areas 74 and 76 and the read-only area 75 in terms of a physical structure (in terms of recording properties). On the other hand, the recording layer 72 can be divided into a lead-in area 81, a user data area 82, and a lead-out area 83, in terms of a data structure (in terms of a logical format). That is, in the recording layer 72, the lead-in area 71 is formed on the inner circumferential side, the user data area 82 is formed on the outer circumferential side of the lead-in area 81, and the lead-out area 83 is formed on the outer circumferential side of the user data area 82.

In the lead-in area 81, identification information 84 which indicates being read-only is recorded in advance. Moreover, in the lead-in area 81, encrypted data 85 by the CSS encryption method is recorded in advance. The identification information 84 and the encrypted data 85 are recorded, for example, by irradiating a predetermined recording position in the lead-in area 81 with a light beam, in a manufacturing process of the single-layer hybrid DVD 70.

Moreover, a file system 86 is recorded in advance in an inner circumferential portion of the user data area 82 following the lead-in area 81. Moreover, in the user data area 82, dummy data 87 is recorded in advance following the file system 86. The file system 86 and the dummy data 87 are recorded, for example, by irradiating a predetermined recording position in the inner circumferential portion of the user data area 82 with a light beam, in the manufacturing process of the single-layer hybrid DVD 70. Incidentally, the length of the dummy data 87 is desirably a length of one or several ECC blocks.

Moreover, the recording layer 72 has an area which is irradiated with a light beam by a DVD player in order to judge the disc type; namely, a disk type judgment area 88. The disk type judgment area 88 is located from a surrounding position where the identification information 84 is recorded in the lead-in area 81 to an inner circumferential portion of the user data area 82 following the lead-in area 81.

On the other hand, in the user data area 82, the outer circumferential side of the area where the dummy data 87 is recorded is unrecorded when the production of the single-layer hybrid DVD 70 is completed and the single-layer hybrid DVD 70 is shipped. Of course, the file system 86 is recorded in advance, and the file system 86 includes in advance management data which indicates the recording position of the file of the content data recorded in the user data area 82. Thus, the recording position of the file of the content data recorded in the user data area 82 is fixed in advance.

As described above, the recording layer 72 has the physical structure, such as the recordable areas 74 and 76 and the read-only area 75, and the data structure, such as the lead-in area 81, the user data area 82, and the lead-out area 83. A positional relationship between the physical structure and the data structure is, for example, as follows.

The read-only area 75 is disposed between the recordable area 74 and the recordable area 76; however, on the whole, the read-only area 75 is disposed on the inner circumferential side of the recording layer 72. Specifically, the read-only area 75 is disposed from a predetermined position in the lead-in area 81 to the inner circumferential portion of the user data area 82 following the lead-in area 81. More specifically, the read-only area 75 is disposed from the surrounding position where the identification information 84 is recorded in the lead-in area 81 (e.g. from immediately before the head position of the identification information 84) to the inner circumferential portion of the user data area 82 following the lead-in area 81. That is, the read-only area 75 overlaps the disk type judgment area 88. Incidentally, the read-only area 75 desirably matches the disk type judgment area 88; however, without being limited to this, the read-only area 75 may be expanded in a wider range including the disk type judgment area 88.

For example, the read-only area 75 is desirably disposed in a range of 22 millimeters or more and 30 millimeters or less in radius, on the basis of an axial line A of the substrate 71. Moreover, the read-only area 75 is desirably disposed to cover a range of 24 millimeters to 27 millimeters in radius, on the basis of the axial line A of the substrate 71. Furthermore, the read-only area is desirably disposed to cover at least a range of 24 millimeters to 28 millimeters in radius, on the basis of the axial line A of the substrate 71.

Based on the positional relationship between the physical structure and the data structure in the recording layer 72, a relationship between the recordable areas 74 and 76 and the read-only area 75 and the recording positions of the identification information 84, the encrypted data 85, the file system 86, and the dummy data 87 or the like is as follows. That is, the identification information 84, the encrypted data 85, and the file system 86 are recorded in the read-only area 75. The dummy data 87 is recorded in a predetermined range including the boundary of the read-only area 75 and the recordable area 76. Moreover, in the recordable area 76, it is unrecorded from the outer circumferential side of the area where the dummy data 87 is recorded to the tail position of the user data area 82 at the factory shipment of the single-layer hybrid DVD 70.

The recording of the content data onto the single-layer hybrid DVD 70 is performed, for example, as follows. A content producer who has purchased the single-layer hybrid DVD 70 records the content data into the unrecorded area of the recordable layer 76 of the single-layer hybrid DVD 70. When the content data is recorded into the unrecorded area of the recordable layer 76, the content data is encrypted by the CSS if needed. When the content data is encrypted by the CSS, the encrypted data 85 is used which is recorded in advance in the read-only layer 75 of the single-layer hybrid DVD 70. Incidentally, when the content data is encrypted by the CSS and is recorded into an unrecorded area of the recordable layer 76, a recording apparatus is used which has a function of encrypting the content data by the CSS and recording it.

Moreover, the recording position of the file of the content data to be recorded into the unrecorded area of the recordable layer 76 is determined in advance from the management data in the file system 86 recorded in the read-only area 75. Thus, when the content data is recorded into the unrecorded area of the recordable layer 76, the content data is authored such that the recording position of the file of the content data matches the recording position indicated by the management data 86 in the file system 86.

The reproduction of the content data encoded by the CSS and recorded in the recordable layer 76 is performed, for example, as follows. A consumer who has obtained the single-layer hybrid DVD 70 on which the content data encrypted by the CSS is recorded in the recordable layer 76 reproduces the content data recorded on the single-layer hybrid DVD 70 by using a DVD player owned by the consumer.

Firstly, if the consumer inserts the single-layer hybrid DVD 70 into the DVD player, the DVD player performs an operation of judging the type of the single-layer hybrid DVD 70. Specifically, the DVD player refers to the identification information 84 recorded on the single-layer hybrid DVD 70 and detects the presence or absence of the wobble by irradiating the read-only area 75, i.e. the disk type judgment area 88 of the single-layer hybrid DVD 70 with a light beam.

The identification information 84 recorded on the single-layer hybrid DVD 70 indicates being read-only. Then, the wobble is not formed in the read-only layer 75. Therefore, the DVD player recognizes that the single-layer hybrid DVD 70 is the read-only DVD.

Then, the DVD player reads the encrypted data 85 by the CSS recorded on the single-layer hybrid DVD 70, and decodes the content data recorded in the recordable layer 76 by using the encrypted data 85. Then, the DVD player reproduces the decoded content data.

As explained above, in the single-layer hybrid DVD 70, the recording layer 72 has the recordable areas 74 and 76 in which the wobble is formed and in which the content data can be written once, and the read-only area 75 in which the wobble is not formed. Moreover, the identification information 84 which indicates being read-only and the encrypted data 85 by the CSS are recorded in advance in the read-only layer 75. By this, it is possible to realize the additional recording of the content data, and it is possible to judge the type of the single-layer hybrid DVD 70 to be the read-only DVD on the DVD player. By this, it is possible to decode and reproduce the content data encrypted by the CSS and recorded on the single-layer hybrid DVD 70, on the DVD player.

Therefore, according to the single-layer hybrid DVD 70, the encrypted content data can be easily recorded onto the single-layer hybrid DVD 70 without using a stampa, and at the same time, it is possible to broaden the model or type of the DVD player that can decode and reproduce the content data encrypted and recorded on the single-layer hybrid DVD 70. Thus, for example, local governments or companies can inexpensively produce the recording disks on which the content data, such as PR activity video images, even in small quantities, and the PR activity video images or the like recorded on the recording disks can be watched by more people. That is, according to the single-layer hybrid DVD 70, it is possible to reduce the cost of the small-quantity production of the contents, and it is possible to increase the number of viewers of the produced contents.

Moreover, in the single-layer hybrid DVD 70, the dummy data 87 is recorded in the vicinity of the boundary of the read-only area 75 and the recordable area 76. By this, when the content data is recorded into the unrecorded area of the recordable area 76 by a recording apparatus, it is possible to start the recording of the content data in such a state that the synchronization between the recording apparatus (DVD recorder) and the single-layer hybrid DVD 70 is certainly provided. That is, the recording apparatus provides the synchronization with the single-layer hybrid DVD 70 on the basis of the wobble. Thus, it cannot provide the synchronization in the read-only area 75 in which the wobble is not formed. The recording apparatus does not record the data into the read-only area 75, so that it does not have to provide the synchronization in the read-only area 75. However, if the spot of the light beam enters the recordable area 76 from the read-only area 75, it is necessary to provide the synchronization. Since the wobble is formed in the recordable area 76, the recording apparatus can provide the synchronization on the basis of the wobble. However, the synchronization may not be stable immediately after the spot of the light beam enters the recordable area 76 from the read-only area 75. Thus, in the single-layer hybrid DVD 70, the dummy data 87 is recorded in the vicinity of the boundary of the read-only area 75 and the recordable area 76, to thereby make the section where the dummy data 87 is recorded function as a so-called entry section to stabilize the synchronization between the recording apparatus and the single-layer hybrid DVD 70. By this, the recording of the content data can be started after the synchronization between the recording apparatus and the single-layer hybrid DVD 70 is stabilized, so that it is possible to increase the stability of the recording of the content data.

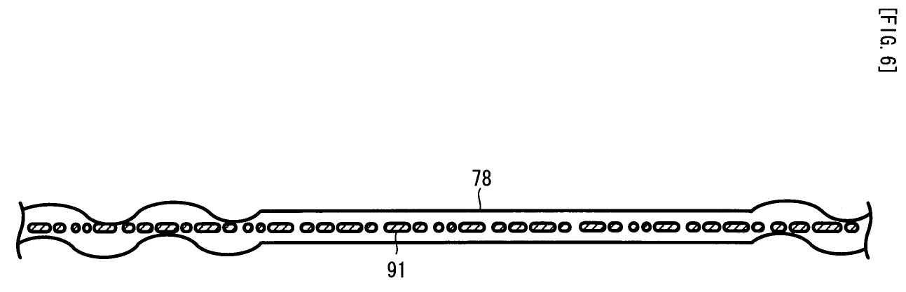

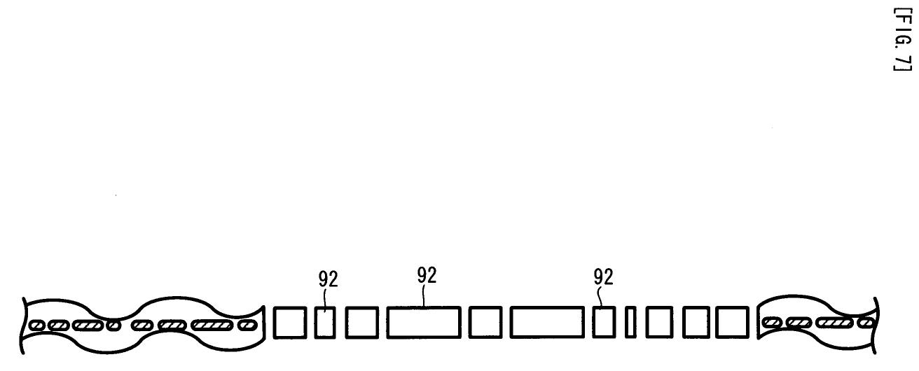

Incidentally, in the aforementioned single-layer hybrid DVD 70, as shown in FIG. 6, the read-only area 75 does not have the wobble formed but has the normal groove 78. In this case, in order to record the identification information 84, the encrypted data 85, and the file system 86 or the like into the read-only area 75, pits 91 are formed by irradiating the groove 78 with a light beam in the manufacturing process. The present invention, however, is not limited to this. For example, as shown in FIG. 7, in the read-only area, embossed pits 92 are formed by forming the groove intermittently, and the identification information, the encrypted data, and the file system or the like may be recorded by changing the length or shape of the embossed pits 92. In this case, in order to increase the degree of modulation, the embossed pits 92 are desirably irradiated with a certain amount of light beam (DC light). By making the groove in the read-only area be the embossed pits 92, the formation of the groove in the recording layer 72 and the recording of the identification information, the encrypted data, and the file system or the like into the read-only area (i.e. the formation of the embossed pits 92, which is the intermittent groove) can be performed in one process in the manufacturing procedure of the single-layer hybrid DVD. Therefore, it is possible to realize a reduction in the number of processes for the production of the single-layer hybrid DVD, a reduction in the manufacturing time, and a reduction in the manufacturing cost.

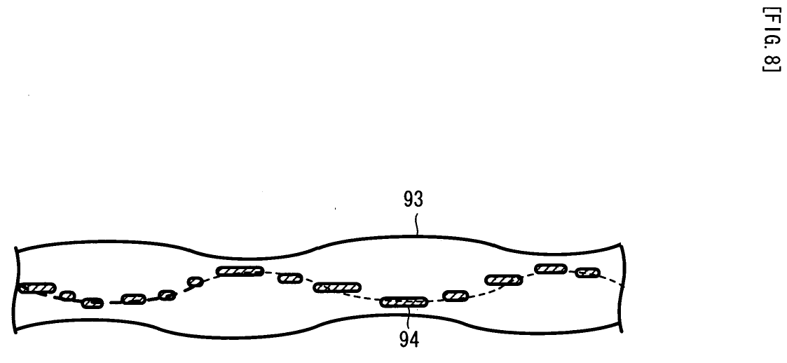

Moreover, in the aforementioned single-layer hybrid DVD, as shown in FIG. 6, the read-only area 75 does not have the wobble formed but is provided with the normal groove 78. However, as shown in FIG. 8, the read-only area may be provided with a wobbled groove 93 in which the wobble is formed. In this case, however, bits 94 recorded in the wobbled groove 93 are arranged undulantly having a phase 180-degrees different from that of the wobble of the wobbled groove 93. By this, the presence of the wobble in the read-only area can be hidden from the reproducing apparatus (DVD player). That is, if the pits 94 recorded in the wobbled groove 93 are arranged undulantly having a phase 180-degrees different from that of the wobble of the wobbled groove 93, most of the distributed DVD players cannot detect the wobble of the wobbled groove 93 and thus judge that the wobbled groove 93 is a normal groove in which the wobble is formed. Therefore, the DVD player can judge that the single-layer hybrid DVD is the read-only DVD.

Incidentally, the aforementioned explanation exemplifies the case that the reproducing apparatus judges whether or not the recording disk is of the read-only type, on the basis of whether or not there is the wobble or whether or not the wobble is detected. The present invention, however, is not limited to this. In the case that the reproducing apparatus judges whether or not the recording disk is of the read-only type, on the basis of other differences in the physical structure between the read-only layer (read-only area) and the recordable layer (recordable area), the physical structure of the read-only layer of the recording disk may be set in accordance with the judgment method of this reproducing apparatus. That is, the difference in the physical structure between the read-only layer (read-only area) and the recordable layer (recordable area) in the recording disk of the present invention is not limited to the structure about the wobble. Of course, as described above, the difference in the physical structure between the read-only layer (read-only area) and the recordable layer (recordable area) is generally the structure about the wobble. Thus, it can be said that the aforementioned recording disks 10 and 20 or the like focusing on the difference in the structure about the wobble have the widest effective scope or applicable scope.

Moreover, in the present invention, various changes may be made without departing from the essence or spirit of the invention which can be read from the claims and the entire specification. A recording disk, which involves such changes, is also intended to be within the technical scope of the present invention.

### INDUSTRIAL APPLICABILITY

The recording disk according to the present invention can be applied to an information recording apparatus, such as a DVD recorder. Moreover, they can be applied to a recording disk which is suited to record content data, such as video images and music.

1. A recording disk comprising: a substrate; and two or more recording layers which are all laminated on one surface of the substrate or which are separately formed on both surfaces,
the recording layer including:
a read-only layer having an area which has a physical structure different from that of a recordable area in which content data can be recorded later, which is read-only, and which is irradiated with a light beam by a reproducing apparatus to judge a type of the disk; and
a recordable layer in which wobble is formed and which has the recordable area,
encrypted data by a CSS (Content Scramble System) encryption method being recorded in advance as embossed pits in the read-only layer.

2. The recording disk according to claim 1, wherein the different physical structure is a structure in which the wobble is not formed.

3. The recording disk according to claim 1, wherein one portion or all of a file system is recorded in advance as the embossed pits in the read-only layer.

4. The recording disk according to claim 1, wherein one portion of a file system is recorded in advance as the embossed pits in the read-only layer, and the one portion of the file system does not include management data which indicates a recording position of a file of the content data to be recorded into the recordable layer.

5. The recording disk according to claim 1, wherein identification information which indicates being read-only is recorded in advance as the embossed pits in the read-only layer.

6-15. (canceled)
